(19) United States
(12) Patent Application Publication
(10) Pub. No.: US 2018/0006983 A1
(43) Pub. Date: Jan. 4, 2018

(54) ENHANCED SEARCH FILTERS FOR EMAILS AND EMAIL ATTACHMENTS IN AN ELECTRONIC MAILBOX

(71) Applicant: Microsoft Technology Licensing, LLC, Redmond, WA (US)

(72) Inventors: Hayley Lynn Steplyk, Redmond, WA (US); Joseph Patrick Masterson, Issaquah, WA (US); Rebecca Jean Lawler, Seattle, WA (US)

(21) Appl. No.: 15/199,730

(22) Filed: Jun. 30, 2016

(51) Int. Cl. H04L 12/58; H04L 29/08

(52) U.S. Cl. CPC H04L 51/12; H04L 67/2804; H04L 51/08; H04L 51/10; H04L 51/22

(57) ABSTRACT

Disclosed herein are technologies for enabling enhanced search filters for emails and email attachments in an electronic mailbox. Email attachments, such as pictures or videos, are analyzed to determine one or more keywords associated with the email attachment. The keywords can identify objects or can use a biometric identification system that identifies the names of humans in the email attachment. Metadata of the email is modified to include the keywords. A user can access their electronic mailbox and search for images using search keywords. Emails having metadata that matches or is relevant to the search keywords are returned as search results.

### BACKGROUND

Computer users often utilize electronic mail (“email”) to communicate with other users. Email is believed to enter use in the late 1960s. Beginning several decades ago with the advent of the Internet, email has quickly become one of the most, if not the most, prevalent forms of communication. Because of its usefulness and convenience, email has also become the de facto storage system for a large portion of its users.

Users receiving communications from others will often persist the email in their “inbox” and not delete the email. Several email providers allow for an almost unlimited amount of emails to be stored in a user's email account. The amount of information in one user's email account, including pictures and videos attached to an email, can become unwieldy.

It is with respect to these and other considerations that the disclosure made herein is presented.

### SUMMARY

Technologies are described herein for enabling enhanced search filters for emails and email attachments in an electronic mailbox. Generally described, the technologies described include an email service application executing on an email server. The email service application is configured to receive an email comprising an attachment, analyze the attachment, and determine one or more keywords to associate with the attachment based on the analysis. In some examples, the attachment is a picture or a video. Various examples of the presently disclosed subject matter analyze the picture to determine one or more keywords associated with the picture.

In some examples, the keywords associated with the emails can be used to search or filter the emails. In some examples, a user is provided a search interface in an email application executing on a receiving device. In some examples, the user is provided a list of search keywords that have been generated for the attachments analyzed in the user's email inbox. The user can select one or more search keywords, causing the email service application to filter out those attachments for display that are not associated with the selected search keyword(s). In other examples, the user is provided with a search ability whereby the user inputs one or more words. The email service application searches the analyzed attachments and determines one or more attachments whose keywords match the searched terms or are relevant to the searched terms.

In some examples, the email service application can analyze attachments of emails and sort the emails into folders based on one or more keywords generated during the analysis. For example, an incoming email may have attached thereto an image file. The image file may be a picture of two different objects. The email service application generates a keyword for each object, generates a mail folder for each keyword, and stores the email with its attachment in the generated mail folder. In some examples, the keyword may be the result of image recognition, whereby the folder is the name of an individual recognized by the email service application.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating a system for enabling enhanced search filters for emails and email attachments in an electronic mailbox.

FIGS. 2A-2C are screen diagrams showing an illustrative graphical user interface that is configured with graphical elements for enabling enhanced search filters for emails and email attachments in an electronic mailbox.

FIG. 3 is a screen diagram showing an illustrative graphical user interface that is configured with graphical elements for using keywords to generate email folders.

FIG. 4 is a flow diagram showing a routine illustrating aspects of a mechanism disclosed herein for generating keywords.

FIG. 5 is a flow diagram showing a routine illustrating aspects of a mechanism disclosed herein for searching images using keywords.

FIG. 6 is a computer architecture diagram illustrating an illustrative computer hardware and software architecture for a computing system capable of implementing the technologies presented herein.

FIG. 7 is a diagram illustrating a distributed computing environment capable of implementing aspects of the technologies presented herein.

FIG. 8 is a computer architecture diagram illustrating a computing device architecture capable of implementing aspects of the technologies presented herein.

### DETAILED DESCRIPTION

The following detailed description is directed to technologies for enabling enhanced search filters for emails and email attachments in an electronic mailbox. When an email having an image or video attached is received by an email server, the email service application invokes a smart filter. The smart filter analyzes the attachment to determine one or more keywords. The keywords are stored with the email as metadata. The keywords can be used in searches or to filter certain emails, among other uses.

Various examples of the presently disclosed subject matter can improve the efficiency of a computer as well as provide additional resources to a user to reduce the time and effort of a user to search for images. As noted above, in a lot of instances, email programs have become a de facto storage system for the users of the email programs. Because email providers are offering ever increasing storage spaces, users are disinclined to download and delete email attachments from their email accounts. Over time, the size of the data representing the stored email attachments can become significant. This affects not only the computing resources of the email provider (operating the email server), but also the ability of a user to effectively search for various images or videos. Some example advantages and improvements are described below.

For a user, various examples of the presently disclosed subject matter provide the user with the ability to search for images using keywords generated through image analysis rather than relying on an email address, name, or date of the email. For example, a user may want to find and delete all pictures in their email account that include a former colleague. Pictures with the former colleague may have been sent by multiple users, and thus, attempts to find pictures with the former colleague using conventional methods entails searching for possible sources of images and then sorting through those images one by one. Using various examples of the presently disclosed subject matter, images having the former colleague can be associated with a keyword from facial recognition. Thus, the user may be able to sort and delete images quicker than what may be possible without the smart filter.

For the entity providing the email server, giving their users the ability to more efficiently and effectively find and delete various images can reduce the storage needs to implement the email service application for the users. Thus, the entity can save on costs, but also reduce its impact on the environment as electrical power to energize the storage banks can be reduced. Further, having an additional search capability in the form of the keywords can reduce the number of searches implemented by a user necessary to find a relevant image, thus reducing the processing load to service the search requests.

By the use of the technologies described herein, a system can provide enhanced search filters for emails and email attachments in an electronic mailbox. Such technologies can improve user interaction with a computing device by providing a filtered list of emails based on keywords derived from attachments of one or more emails, including images and other datatypes. Configurations disclosed herein can be beneficial in assisting users and business entities by providing filtered lists of emails to help users navigate one of these emails. Technologies that enable users to readily locate emails reduce the need for users to send requests for duplicate copies. Among many benefits provided by the technologies described herein, a user's interaction with a device may be improved, which may reduce the number of inadvertent inputs, reduce the consumption of processing resources, and mitigate the use of network resources. Other technical effects other than those mentioned herein can also be realized from implementations of the technologies disclosed herein.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, in which like numerals represent like elements throughout the several figures, aspects of technologies for enabling enhanced search filters for emails and email attachments in an electronic mailbox will be presented.

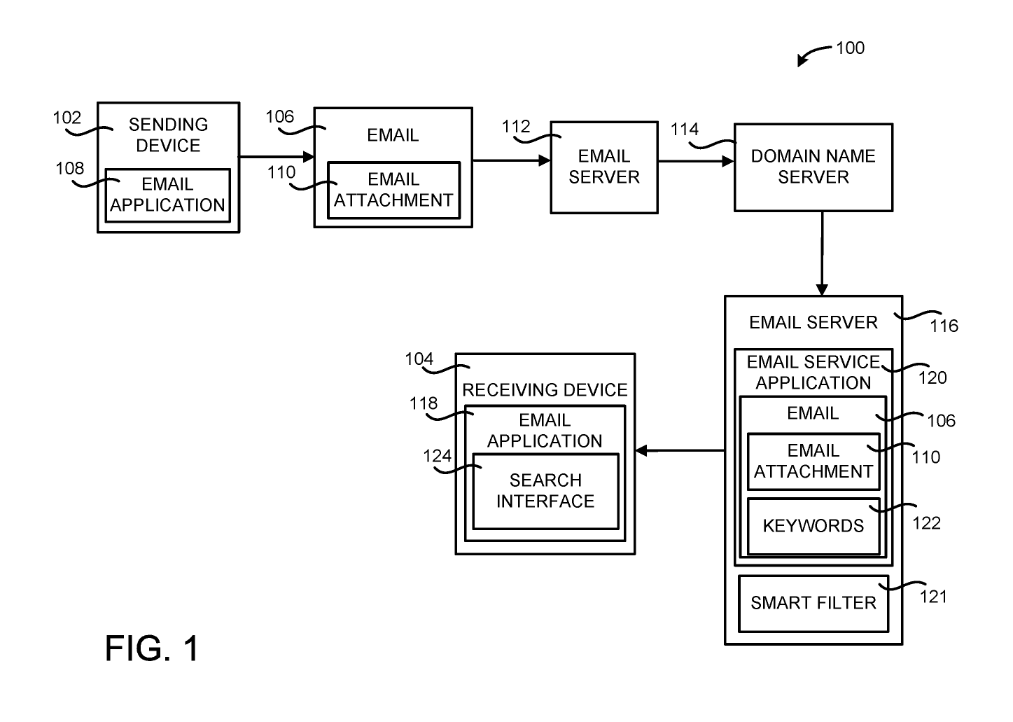

Referring now to FIG. 1, aspects of an email system 100 for providing a smart filter to search for files in an electronic mailbox. The email system 100 shown in FIG. 1 includes a sending device 102 and a receiving device 104. The sending device 102 is the device used to create an email 106 and the receiving device 104 is the device used to receive and access the email. According to various configurations, the functionality of the sending device 102 or the receiving device 104 can be provided by a personal computer (“PC”) such as a desktop, tablet, or laptop computer system. In some other configurations, the functionality of the sending device 102 or the receiving device 104 can be provided by other types of computing systems including, but not limited to, a handheld computer, a netbook computer, an embedded computer system, a mobile telephone, a smart phone, or another computing device. It should be understood that these examples are illustrative, and should not be construed as being limiting in any way.

The sending device 102 is configured to provide functionality for an email application 108. The email application 108 can be any type of email application that provides for the ability of a user to generate an email. In some examples, the email application 108 provides for the ability of a user to attach to the email an email attachment 110. In some examples, the email attachment 110 is a picture, video, and the like.

Once the email 106 with the email attachment 110 is generated using the email application 108, the sending device 102 transmits the email 106 to an email server 112. In the example illustrated in FIG. 1, the email server 112 is an outgoing email server known as Simple Mail Transfer Protocol (“SMTP”) server. The SMTP server processes the domain name of an email address accessed through the receiving device 104.

In some examples, if the domain name of the email address accessed through receiving device 104 is the same as the sender's, the message is routed directly over to the domain's POP3 or IMAP server (not shown). If the domain is different, though, the email server 112 accesses a domain name server 114 to determine an email server 116 associated with the email address accessed through the receiving device 104. It should be understood that the above description is merely exemplary, as other email system configurations may be used to provide aspects of the presently disclosed subject matter.

Once received at the email server 116, a user (not shown) can access the email 106, with its email attachment 110, using an email application 118. The email application 118 is an application configured to provide access to an email service application 120 that stores and provides access to the email 106. The email application 118 can be a local application executing on the receiving device 104 or can be an interface provided by the email service application 116 executing through an Internet browser. Examples of the email service application 120 include YAHOO! Mail provided by Yahoo, Inc. of Sunnyvale, Calif., and GMAIL provided by Alphabet, Inc. of Mountain View, Calif. It should be noted, however, that the presently disclosed subject matter is not limited to any particular type or configuration of the email application 118 or the email service application 120.

In examples of the presently disclosed subject matter, when the email 106 is received, the email service application 120 determines if the email 106 includes the email attachment 110. If the email service application 120 determines that the email 106 includes the email attachment 110, the email service application 120 determines if the email attachment 110 is an attachment that can be analyzed to generate a keyword. In some examples, email attachments 110 include various types of data and other information that may not be suitable for analysis to generate a keyword.

If the email service application 120 determines that the email attachment 110 is an attachment that can be analyzed to generate a keyword, the email service application 120 invokes a smart filter 121. In some examples, the smart filter 121 is an application designed to scan images or other data file types to determine one or more keywords associated with the image. The smart filter 121 can use various image analysis engines, such as the image search engine used by the BING image search application provided by Microsoft Corporation of Redmond, Wash.

The smart filter 121 analyzes the image and determines one or more keywords that the smart filter 121 determines describe the image. For example, an image may include a horse with a duck. The smart filter 121 can analyze the image and determine that the keywords DUCK and HORSE describe the image. It should be appreciated that the term “describe” can vary depending on the image search engine used and the configuration of the image search engine.

For example, an image search engine can be configured to determine not only the objects within an image, but the context of the objects within the image. For example, the image may be of the horse and the duck on a farm at night. While the smart filter 121 determines the keywords DUCK and HORSE as objects, the smart filter 121 can also determine the keyword NIGHT as a context of the image.

Once the smart filter 121 determines keywords 122 to be associated with the email attachment 110, the smart filter 121 provides the keywords 122 to the email service application 120. The email service application 120 modifies the metadata of the email 106 to include the keywords 122. The keywords 122 can thereafter be used by a user to search for the email 106 or the email attachment 110 using not only the email address of the sender, but also the keywords 122 associated with the image attachment 110.

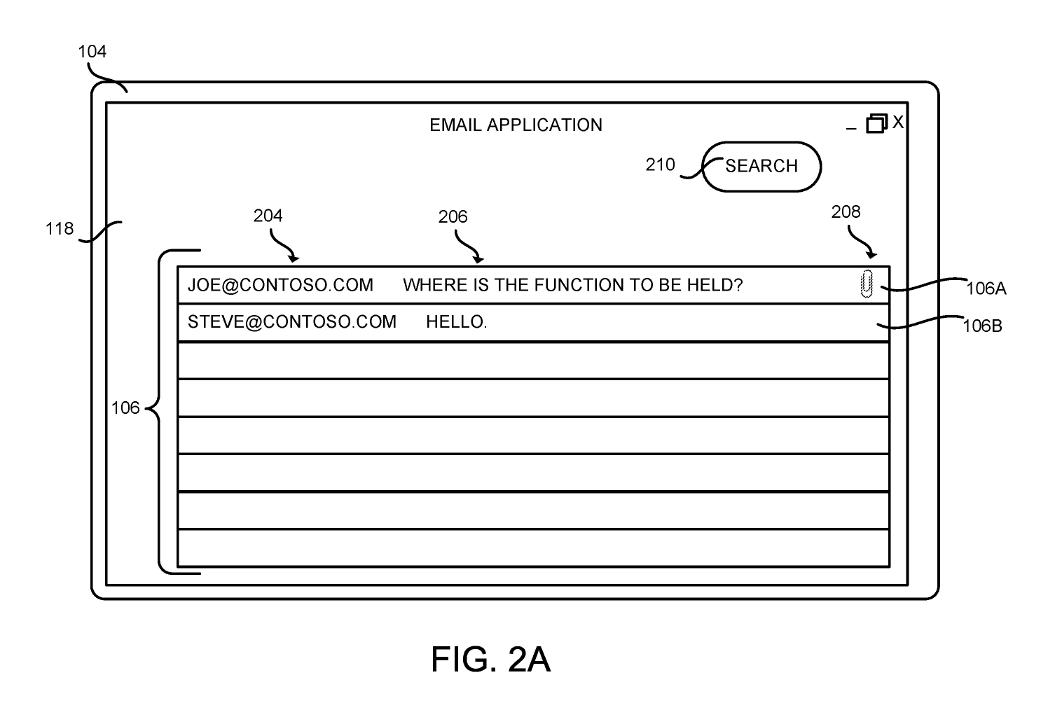

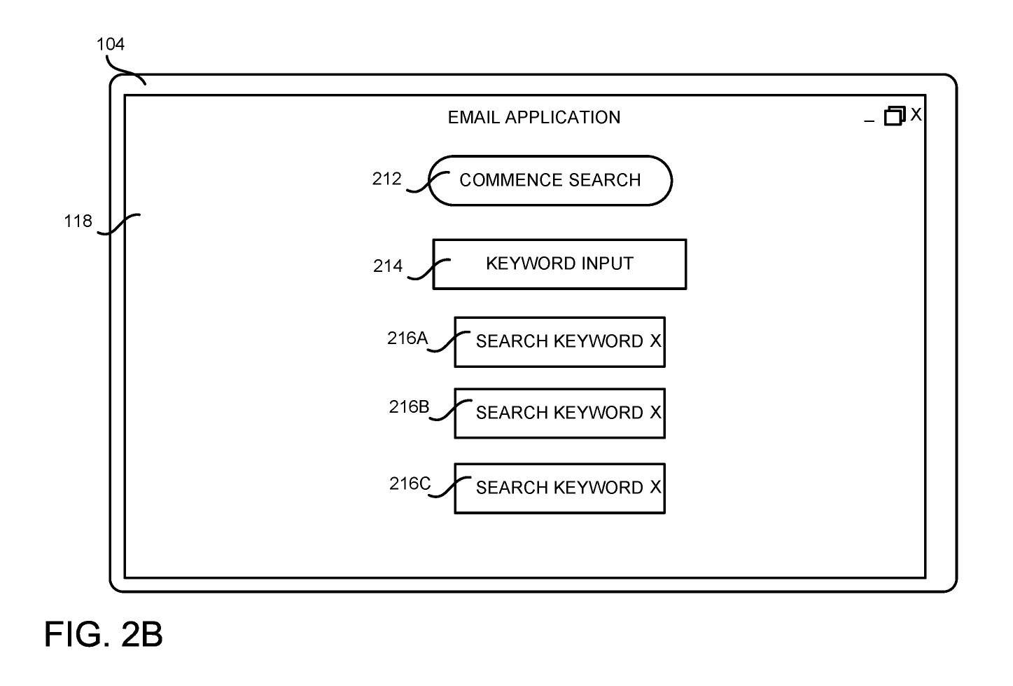

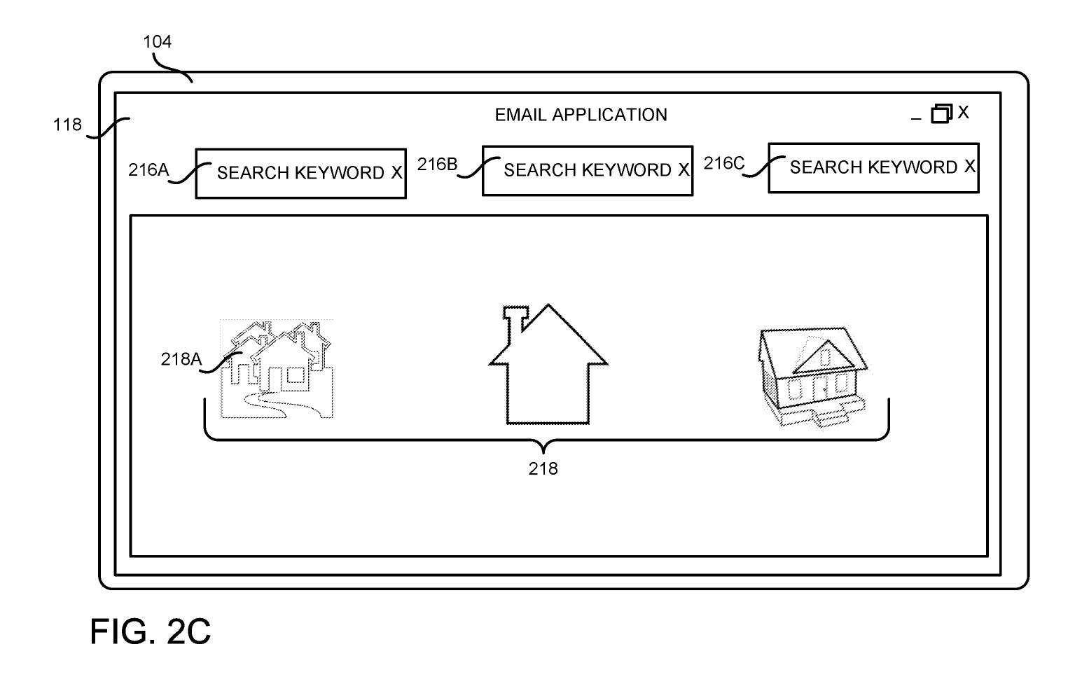

In some examples, and as more fully described by way of example below, the email application 118 can provide a search feature to allow a user to search for images using the keywords 122. In some examples, the email application 118 includes a search interface 124. As described in more detail in FIGS. 2A-2C below, the search interface 124 can include a search input for receiving one or more words (“search string”) to be used to search the email service application 120. The email service application 120 uses the search string to determine which emails 106 include image attachments 110 with keywords 122 relevant to the search string.

FIGS. 2A-2C are user interface diagrams showing the use of the search interface 124 to search for image attachments 110. In FIG. 2A, the receiving device 104 is shown with the email application 118 executing on the receiving device 104. The email application 118 can have displayed therein a plurality of emails 106 received from a variety of sending devices 102. The emails 106 can have some identifying information displayed with the emails 106. In the example illustrated in FIG. 2A, the emails 106 include an address 204 of the sender of the email 106 and a subject line 206 of the emails 106.

Also shown is an attachment indicator 208 that is used to indicate that the email 106 includes an email attachment 110. As shown in FIG. 2A, some of the emails 106 include email attachments 110, whereas some of the emails 106 do not. By way of example, email 106A includes an email attachment 110 (illustrated using an image of a paperclip), whereas email 106B does not include an email attachment 110.

During the use of the email application 118, a user may want to search the emails 106 to determine if the emails 106 have certain email attachments 110 of pictures or videos. Thus, the email application 110 includes a search input 210. The search input 210 receives an indication that a user wishes to search the emails 106 and invokes a search function, shown in FIG. 2B.

FIG. 2B is an illustration of the email application 118 executing a search function. Upon receipt of an input at the search input 210, the email application executes a search function. The email application 118 has displayed therein a commence search input 212. The commence search input 212 is configured to receive an input to commence a search.

The email application 118 also has displayed therein a keyword input 214. The keyword input 214 is configured to receive a word or terms used in a search. The search function can include more than one word or term, as indicated by search keywords 216A-216C. In some examples, the search keywords 216A-216C are generated by an input from a user. In other examples, the search keywords 216A-216C are generated from other sources as well. For example, the search keywords 216A-216C can be automatically provided when the search function is invoked. The search keywords 216A-216C can be a listing of keywords 122 already determined by the smart filter 121. In this manner, in some examples, the search keywords 216A-216C can provide guidance to a user by providing a list of already determined search keywords 216A-216C.

Upon a receipt of an input at a commence search input 212, the email service application 120 commences a search for email attachments 110 associated with the search keywords 216A-216C. As discussed above, the manner in which the search is conducted may vary. For example, the email service application 120 can receive the search keywords 216A-216C and search for images having the same or related keywords associated with them. For example, the search keyword 216A can be house. The email service application 120 can search for images with the keyword 122 house, but can also look for images having similar or related keywords 122 like HOME, BUILDING, RESIDENCE, and the like. The presently disclosed subject matter is not limited to any particular searching technology.

FIG. 2C is an illustration of the email application 118 after executing a search function. The email application 118 has displayed therein search results 218. The search results 218 are associated with emails 106 that have email attachments 110 with keywords 122 relevant to the search keywords 216. In the example illustrated in FIG. 2C, the search results 218 are displayed as images. It should be understood that other ways of displaying the search results 218 can be used and are considered to be within the scope of the presently disclosed subject matter.

The search results 218 can be active links to their respective emails 106. For example, a user may select search result 218A. When selected, the related email containing the search result 218A may be displayed. For example, if email 106A is associated with the search result 218A, the selection of the search result 218A can result in the email application 118 displaying the email 106A.

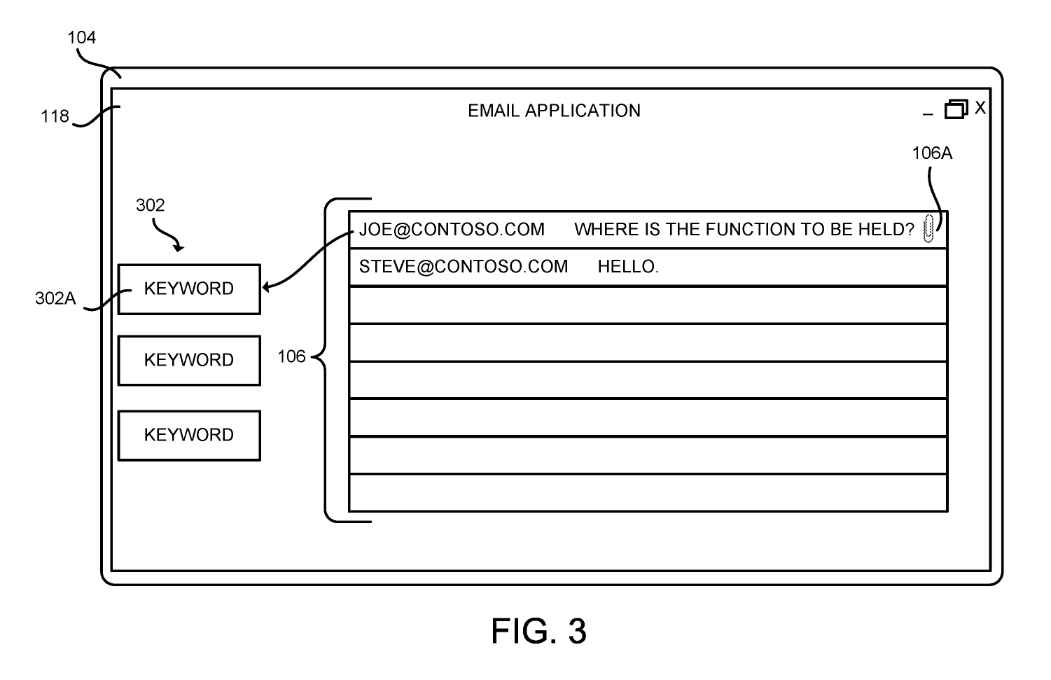

FIG. 3 is an illustration of the email application 118 using the keywords 122 for email sorting. In FIG. 3, the email application 118 has displayed therein the emails 106. As noted above, in some examples, the email service application 120 can analyze emails 106 and determine one or more keywords 122 associated with the email attachment 110. As discussed above, the keywords 122 can be used for various purposes. The example illustrated in FIGS. 2A-2C illustrate the use of the keywords 122 to search for images.

In FIG. 3, the keywords 122 are used to generate folders 302. The name of the folders 302 can be the keywords 122. The email service application 120 can analyze the emails 106, determine one or more keywords 122 associated with the email attachment 110. The email service application 120 can move the email 106 to the folder with the keyword 122 generated or can generate a new folder if the keyword 122 has not been previously generated, and thereafter move the email 106 to the folder with the keyword 122. In FIG. 3, the email attachment 110 of the email 106A has been determined to have a keyword 122 associated with a folder 302A. In this example, the email 106A may be routed to the folder 302A.

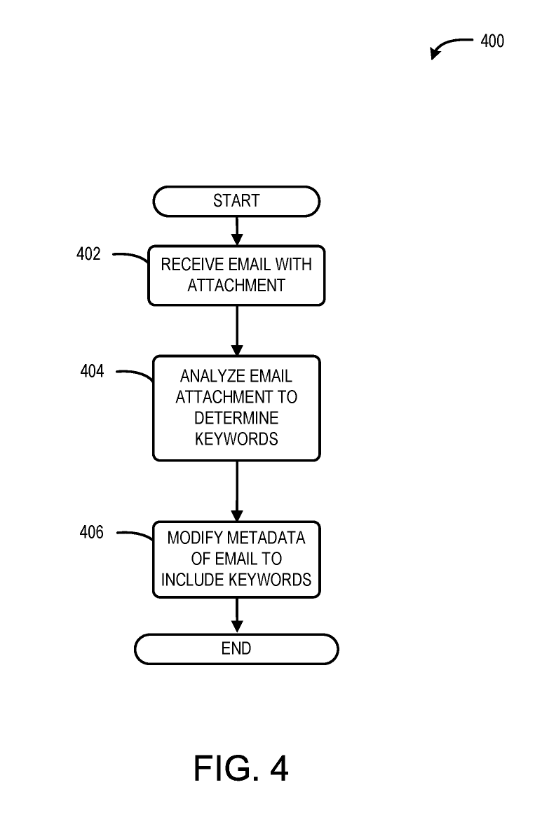

FIG. 4 is a flow diagram showing aspects of a method 400 disclosed herein for enabling enhanced search filters for emails and email attachments in an electronic mailbox. It should be understood that the operations of the method 400 are not necessarily presented in any particular order and that performance of some or all of the operations in an alternative order(s) is possible and is contemplated. The operations have been presented in the demonstrated order for ease of description and illustration. Operations can be added, omitted, and/or performed simultaneously, without departing from the scope of the appended claims.

It also should be understood that the illustrated method 400 can be ended at any time and need not be performed in its entirety. Some or all operations of the method 400, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules can be implemented in software, in firmware, in special purpose digital logic, and any combination thereof.

For purposes of illustrating and describing the technologies of the present disclosure, the method 400 disclosed herein is described as being performed by the email server 116 via execution of computer executable instructions such as, for example, the email service application 120. As explained above, the email service application 120 can include functionality for enabling enhanced search filters for emails and email attachments in an electronic mailbox. While the method 400 is described as being provided by the email server 116, it should be understood that the functionality described herein can be provided by various devices, such as the receiving device 104, via execution of various application program modules and/or elements. Additionally, devices other than, or in addition to, the email server 116 can be configured to provide the functionality described herein via execution of computer executable instructions other than, or in addition to, the email service application 120. As such, it should be understood that the described configuration is illustrative, and should not be construed as being limiting in any way.

The method 400 begins at operation 402, where an email 106 is received with an email attachment 110. The email 106 can be received using various forms of electronic mail systems. The presently disclosed subject matter is not limited to any particular form of electronic mail system. For the purposes of FIG. 4, the email 106 is considered to be received at the email server 116.

The method 400 continues to operation 404, where the email attachment 110 is analyzed by the smart filter 121 to determine one or more keywords 122. The presently disclosed subject matter is not limited to any particular form of analysis. In some examples, the analysis identifies objects such as HORSE or CAT. In other examples, the analysis is a biometric identification system that identifies the names of humans (or other animals) in the email attachment 110. For example, the biometric identification system may use facial recognition to determine that the email attachment 110 comprises a person named SALLY.

In some examples, the email attachment 110 may be a picture or a video. In some examples involving videos, the smart filter 121 can determine if the video is associated with a thumbnail or other image metadata that can provide for the generation of the keywords. In other examples, the smart filter 121 can analyze the video to determine one or more prominent images contained in the video.

The method 400 continues to operation 406, where the metadata of the email 106 is modified to include the keywords 122 identified by the smart filter 121. In some examples, the modification of the metadata associated with the email 106 can provide textual information on which a search can be performed. Thereafter, the method 400 can end.

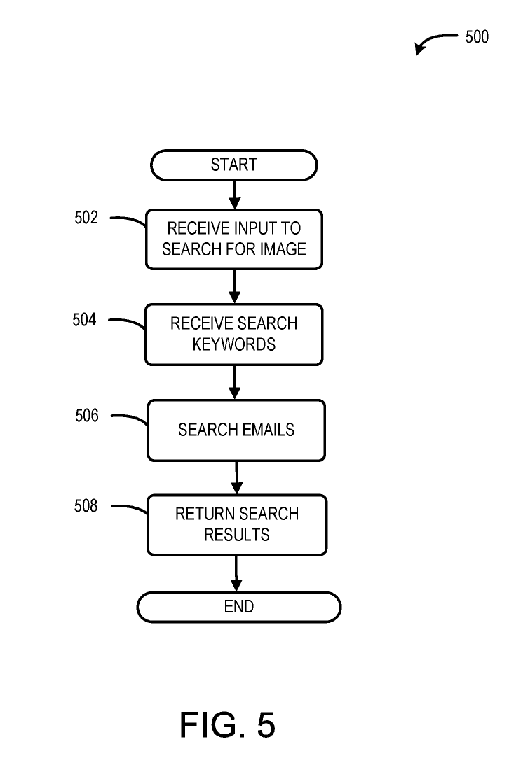

FIG. 5 is a flow diagram showing aspects of a method 500 disclosed herein for searching images associated with a keyword. The method 500 commences at operation 502, where an input is received to search for an image associated with an email 106. The input can be received in various ways. In some examples, the input can be received from the receipt of a selection made by a user to commence a search function. In other examples, the input can be a process used by the email service application 120 to filter or sort email attachments 110. For example, the email service application 120 can have an automated process whereby images with certain objects are searched for and deleted from a user's inbox.

The method 500 continues to operation 504, where the search keywords 216 are received to perform the search. The search keywords 216 can be received from various sources. In some examples, the search keywords 216 can be one or more terms of a search string received from a user input. In other examples, the search keywords 216 can be provided by the email service application 120, whereby the search keywords 216 is a list of the keywords 122 previously generated.

The method 500 continues to operation 506, where the email service application 120 searches emails 106 using the search keywords 216. In some examples, the scope of the search may be limited to emails 106 associated with keywords 122 that are identical to the search keywords 216. In other examples, the scope of the search may encompass the keywords 122 that are related to or associated with the search keywords 216.

The method 500 continues to operation 508, where the search results 218 are provided. The search results 218 can be displayed in various formats. For example, the search results 218 can be rendered as pictures in a list. In other examples, the search results 218 can be list of emails having attachments relevant to the search. The method 500 can thereafter end.

The present disclosure also encompasses the subject matter set forth in the following clauses:

Clause 1. A computer-implemented method, the method comprising receiving an email comprising an email attachment, analyzing the email attachment to determine a keyword, modifying metadata of the email to include the keyword, and storing the email with the modified metadata for access by a user.

Clause 2. The computer-implemented method of any of the prior clauses, wherein the email attachment comprises a picture.

Clause 3. The computer-implemented method of any of the prior clauses, wherein the email attachment comprises a video.

Clause 4. The computer-implemented method of any of the prior clauses, wherein analyzing the email attachment comprises determining the identification of at least one object in the email attachment.

Clause 5. The computer-implemented method of any of the prior clauses, wherein analyzing the email attachment comprises determining the identification of an individual in the email attachment through biometric identification.

Clause 6. The computer-implemented method of any of the prior clauses, further comprising using the keyword to generate a folder to store the email and storing the email in the folder.

Clause 7. The computer-implemented method of any of the prior clauses, further comprising receiving an input to search for an image from a plurality of emails, receiving a search keyword, searching the plurality of emails, determining the keyword associated with the email comprising the email attachment is relevant to the search keyword, and returning the email attachment as a search result.

Clause 8. The computer-implemented method of any of the prior clauses, wherein the search keyword is determined from a plurality of keywords generated from an analysis of the plurality of emails.

Clause 9. The computer-implemented method of any of the prior clauses, further comprising determining if the email attachment comprises a thumbnail that can provide for the generation of the keyword.

Clause 10. A computer-readable storage medium having computer-executable instructions stored thereupon that, when executed by a computer, cause the computer to receive an email comprising an email attachment, analyze the email attachment to determine a keyword, modify metadata of the email to include the keyword, and store the email with the modified metadata for access by a user.

Clause 11. The computer-readable storage medium of any of the prior clauses, wherein the email attachment comprises a picture.

Clause 12. The computer-readable storage medium of any of the prior clauses, wherein the email attachment comprises a video.

Clause 13. The computer-readable storage medium of any of the prior clauses, wherein the computer-executable instructions to analyze the email attachment comprises computer-executable instructions to determine the identification of at least one object in the email attachment.

Clause 14. The computer-readable storage medium of any of the prior clauses, wherein the computer-executable instructions to analyze the email attachment comprises computer-executable instructions to determine the identification of an individual in the email attachment through biometric identification.

Clause 15. The computer-readable storage medium of any of the prior clauses, further comprising computer-executable instructions to use the keyword to generate a folder to store the email and store the email in the folder.

Clause 16. The computer-readable storage medium of any of the prior clauses, further comprising computer-executable instructions to receive an input to search for an image from a plurality of emails, receive a search keyword, search the plurality of emails, determine the keyword associated with the email comprising the email attachment is relevant to the search keyword, and return the email attachment as a search result.

Clause 17. The computer-readable storage medium of any of the prior clauses, wherein the search keyword is determined from a plurality of keywords generated from an analysis of the plurality of emails.

Clause 18. A system comprising a processor, and a computer-readable storage medium in communication with the processor, the computer-readable storage medium having computer-executable instructions stored thereupon which, when executed by the processor, cause the processor to analyze a plurality of emails to determine one or more keywords associated with a plurality of email attachments of the plurality of emails, display the one or more keywords on a user interface, receive input data indicating a selection of at least one keyword of the one or more keywords, and filter the plurality of emails based on the at least one keyword to generate a set of filtered emails.

Clause 19. The system of any of the prior clauses, wherein the computer-executable instructions comprise instructions to return the plurality of email attachments associated with the set of filtered emails as a search result.

Clause 20. The system of any of the prior clauses, wherein the email attachment comprises a picture or a video.

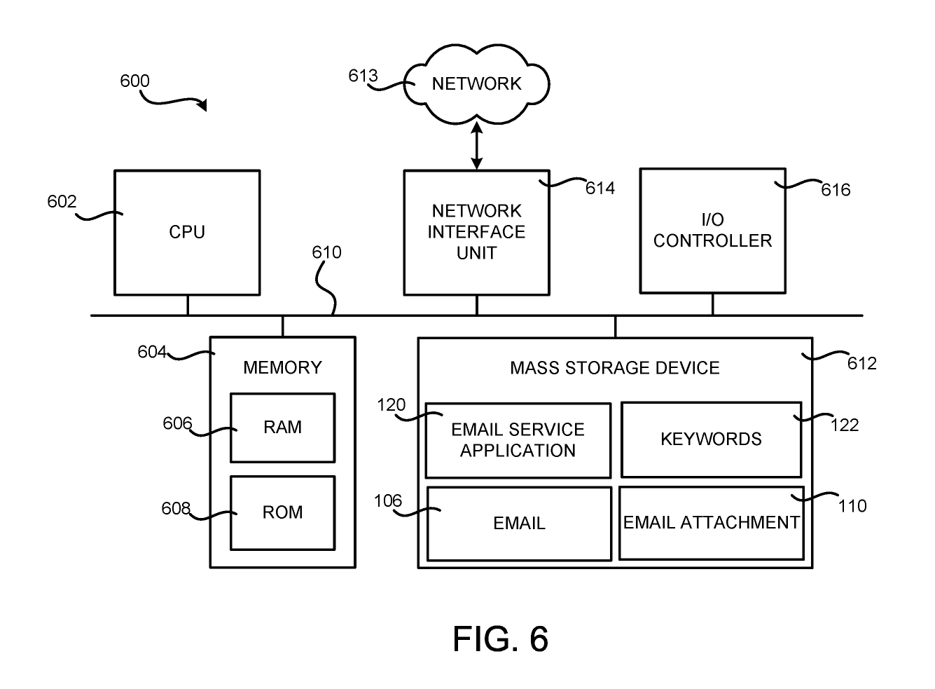

FIG. 6 illustrates an illustrative computer architecture 600 for a device capable of executing the software components described herein for enabling enhanced search filters for emails and email attachments in an electronic mailbox. Thus, the computer architecture 600 illustrated in FIG. 6 illustrates an architecture for a server computer, mobile phone, a smart phone, a desktop computer, a netbook computer, a tablet computer, and/or a laptop computer. The computer architecture 600 can be utilized to execute any aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing, by way of example, and not by way of limitation, the email service application 120, the email 106, the email attachment 110, and the keywords 122.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 600 can operate in a networked environment using logical connections to remote computers through a network such as the network 613. The computer architecture 600 can connect to the network 613 through a network interface unit 614 connected to the bus 610. It should be appreciated that the network interface unit 614 can also be utilized to connect to other types of networks and remote computer systems.

The computer architecture 600 can also include an input/output controller 616 for receiving and processing input from a number of other devices, including a keyboard, mouse, or electronic stylus (not shown in FIG. 6). Similarly, the input/output controller 616 can provide output to a display screen, a printer, or other type of output device (also not shown in FIG. 6).

It should be appreciated that the software components described herein can, when loaded into the CPU 602 and executed, transform the CPU 602 and the overall computer architecture 600 from a general-purpose computing system into a special-purpose computing system customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein. These computer-executable instructions can transform the CPU 602 by specifying how the CPU 602 transitions between states, thereby transforming the transistors or other discrete hardware elements constituting the CPU 602.

Encoding the software modules presented herein can also transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 can include other types of computing devices, including hand-held computers, embedded computer systems, personal digital assistants, and other types of computing devices known to those skilled in the art. It is also contemplated that the computer architecture 600 might not include all of the components shown in FIG. 6, can include other components that are not explicitly shown in FIG. 6, or might utilize an architecture completely different than that shown in FIG. 6.

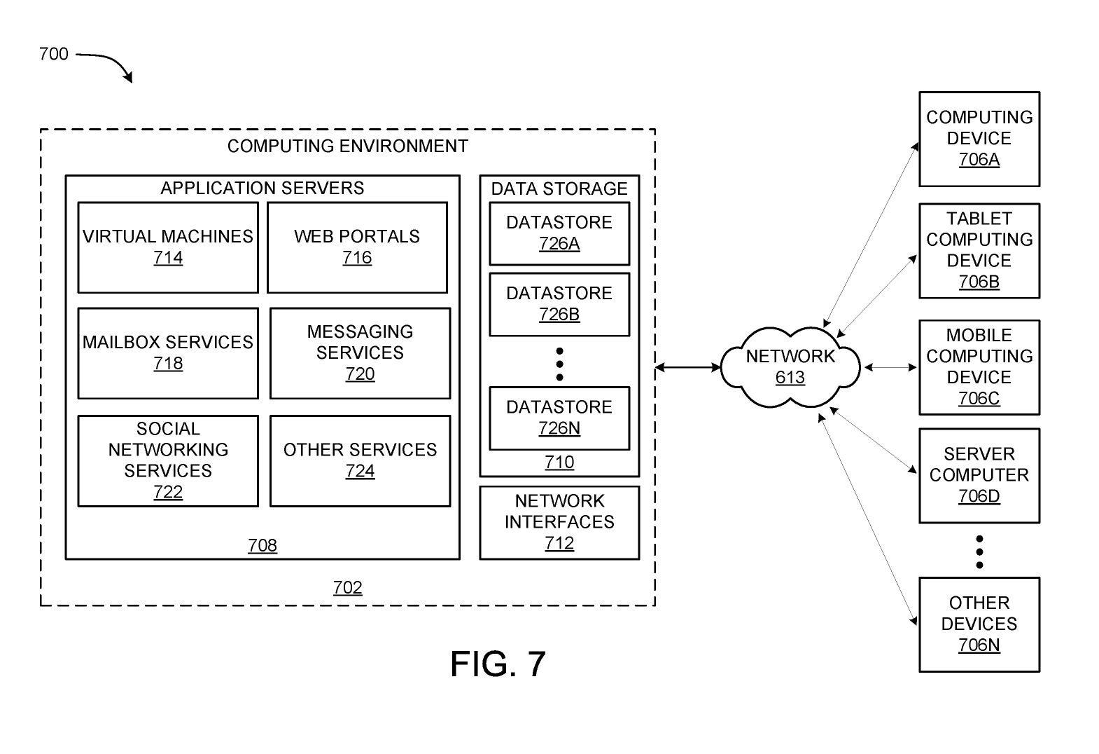

FIG. 7 illustrates an illustrative distributed computing environment 700 capable of executing the software components described herein for enabling enhanced search filters for emails and email attachments in an electronic mailbox. Thus, the distributed computing environment 700 illustrated in FIG. 7 can be used to provide the functionality described herein with respect to the sending device 102, the receiving device 104, or the email server 116. The distributed computing environment 700 can be utilized to execute any aspects of the software components presented herein.

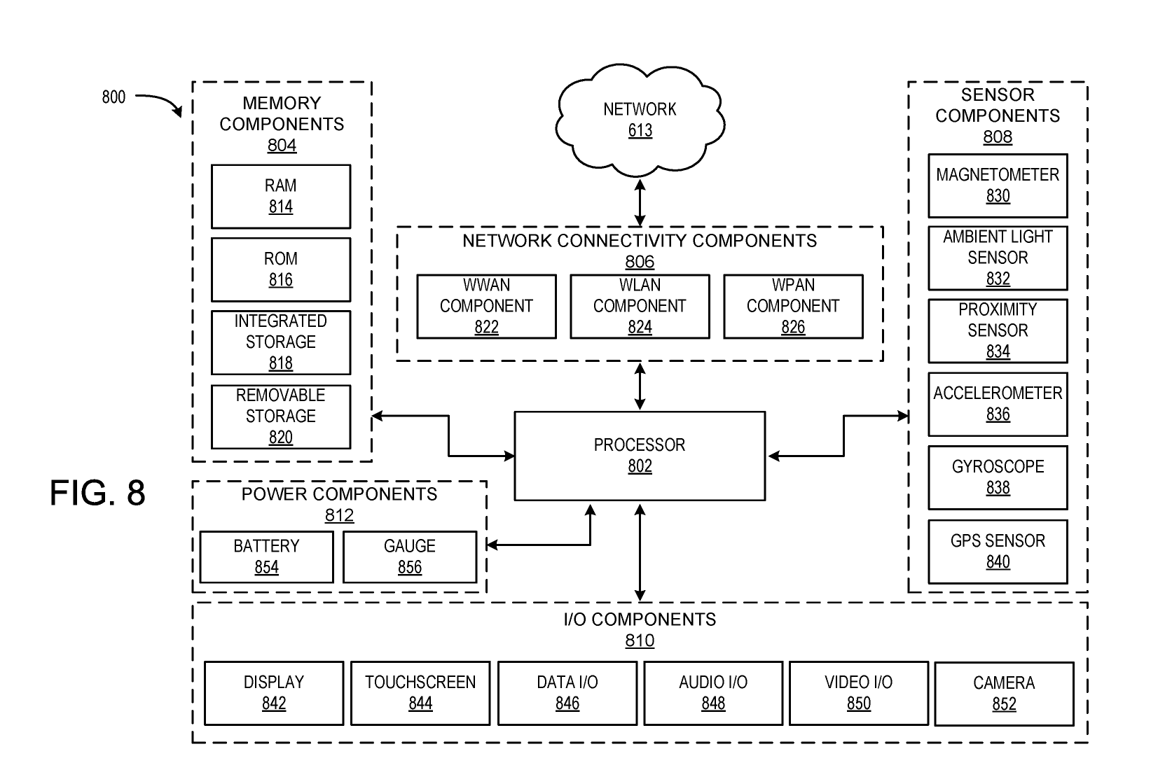

According to various implementations, the distributed computing environment 700 includes a computing environment 702 operating on, in communication with, or as part of the network 613. The network 613 also can include various access networks. One or more client devices 706A-706N (hereinafter referred to collectively and/or generically as “clients 706”) can communicate with the computing environment 702 via the network 613 and/or other connections (not illustrated in FIG. 7). In the illustrated configuration, the clients 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of clients 706 can communicate with the computing environment 702. Two example computing architectures for the clients 706 are illustrated and described herein with reference to FIGS. 7 and 8. It should be understood that the illustrated clients 706 and computing architectures illustrated and described herein are illustrative, and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 613. The application servers 708 can host various services, virtual machines, portals, and/or other resources. In the illustrated configuration, the application servers 708 host one or more virtual machines 714 for hosting applications or other functionality. According to various implementations, the virtual machines 714 host one or more applications and/or software modules for providing the functionality described herein. It should be understood that this configuration is illustrative, and should not be construed as being limiting in any way. The application servers 708 also host or provide access to one or more Web portals, link pages, Web sites, and/or other information (“Web portals”) 716.

According to various implementations, the application servers 708 also include one or more mailbox services 718 and one or more messaging services 720. The mailbox services 718 can include electronic mail (“email”) services. The mailbox services 718 also can include various personal information management (“PIM”) services including, but not limited to, calendar services, contact management services, collaboration services, and/or other services. The messaging services 720 can include, but are not limited to, instant messaging services, chat services, forum services, and/or other communication services.

The application servers 708 also can include one or more social networking services 722. The social networking services 722 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 722 are provided by or include the FACEBOOK social networking service, the LINKEDIN professional networking service, the MYSPACE social networking service, the FOURSQUARE geographic networking service, the YAMMER office colleague networking service, and the like.

In other configurations, the social networking services 722 are provided by other services, sites, and/or providers that might or might not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, FACEBOOK from Facebook, Inc. in Menlo Park, Calif., TWITTER from Twitter, Inc. in San Francisco, Calif., GOOGLE+ from Alphabet, Inc. in Mountain View, Calif., and LINKEDIN from LinkedIn Corporation in Mountain View, Calif. Other services are possible and are contemplated.

The social networking services 722 also can include commenting, blogging, and/or microblogging services. Examples of such services include, but are not limited to, the YELP commenting service, the KUDZU review service, the OFFICETALK enterprise microblogging service, the TWITTER messaging service, and/or other services. It should be appreciated that the above lists of services are not exhaustive and that numerous additional and/or alternative social networking services 722 are not mentioned herein for the sake of brevity. As such, the above configurations are illustrative, and should not be construed as being limited in any way.

As shown in FIG. 7, the application servers 708 also can host other services, applications, portals, and/or other resources (“other resources”) 724. It therefore can be appreciated that the computing environment 702 can provide integration of the technologies disclosed herein provided herein for enabling enhanced search filters for emails and email attachments in an electronic mailbox with various mailbox, messaging, social networking, and/or other services or resources.

As mentioned above, the computing environment 702 can include the data storage 710. According to various implementations, the functionality of the data storage 710 is provided by one or more databases operating on, or in communication with, the network 613. The functionality of the data storage 710 also can be provided by one or more server computers configured to host data for the computing environment 702. The data storage 710 can include, host, or provide one or more real or virtual data stores 726A-726N (hereinafter referred to collectively and/or generically as “data stores 826”). The data stores 726 are configured to host data used or created by the application servers 708 and/or other data.

The computing environment 702 can communicate with, or be accessed by, the network interfaces 712. The network interfaces 712 can include various types of network hardware and software for supporting communications between two or more computing devices including, but not limited to, the clients 706 and the application servers 708. It should be appreciated that the network interfaces 712 can also be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the technologies disclosed herein, the distributed computing environment 700 provides the software functionality described herein as a service to the clients 706. It should be understood that the clients 706 can include real or virtual machines including, but not limited to, server computers, web servers, personal computers, mobile computing devices, smart phones, and/or other devices. As such, various configurations of the technologies disclosed herein enable any device configured to access the distributed computing environment 700 to utilize the functionality described herein for enabling enhanced search filters for emails and email attachments in an electronic mailbox.

Turning now to FIG. 8, an illustrative computing device architecture 800 for a computing device that is capable of executing various software components described herein for enabling enhanced search filters for emails and email attachments in an electronic mailbox is described. The computing device architecture 800 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. Moreover, the computing device architecture 800 is applicable to any of the clients 806 shown in FIG. 8. Furthermore, aspects of the computing device architecture 800 can be applicable to traditional desktop computers, portable computers (e.g., laptops, notebooks, ultra-portables, and netbooks), server computers, and other computer systems, such as described herein with reference to FIG. 7. For example, the single touch and multi-touch aspects disclosed herein below can be applied to desktop computers that utilize a touchscreen or some other touch-enabled device, such as a touch-enabled track pad or touch-enabled mouse.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individuals components illustrated in FIG. 8, the components can interact to carry out device functions. In some configurations, the components are arranged so as to communicate via one or more busses (not shown).

The processor 802 includes a central processing unit (“CPU”) configured to process data, execute computer-executable instructions of one or more application programs, and communicate with other components of the computing device architecture 800 in order to perform various functionality described herein. The processor 802 can be utilized to execute aspects of the software components presented herein and, particularly, those that utilize, at least in part, a touch-enabled input.

In some configurations, the processor 802 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some configurations, the processor 802 is configured to communicate with a discrete GPU (not shown). In any case, the CPU and GPU can be configured in accordance with a co-processing CPU/GPU computing model, wherein the sequential part of an application executes on the CPU and the computationally-intensive part is accelerated by the GPU.

In some configurations, the processor 802 is, or is included in, a system-on-chip (“SoC”) along with one or more of the other components described herein below. For example, the SoC can include the processor 802, a GPU, one or more of the network connectivity components 806, and one or more of the sensor components 808. In some configurations, the processor 802 is fabricated, in part, utilizing a package-on-package (“PoP”) integrated circuit packaging technique. Moreover, the processor 802 can be a single core or multi-core processor.

The processor 802 can be created in accordance with an ARM architecture, available for license from ARM HOLDINGS of Cambridge, United Kingdom. Alternatively, the processor 802 can be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a random access memory (“RAM”) 814, a read-only memory (“ROM”) 816, an integrated storage memory (“integrated storage”) 818, and a removable storage memory (“removable storage”) 820. In some configurations, the RAM 814 or a portion thereof, the ROM 816 or a portion thereof, and/or some combination the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 or the removable storage 820.

The integrated storage 818 can include a solid-state memory, a hard disk, or a combination of solid-state memory and a hard disk. The integrated storage 818 can be soldered or otherwise connected to a logic board upon which the processor 802 and other components described herein can also be connected. As such, the integrated storage 818 is integrated in the computing device. The integrated storage 818 is configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available and shown to a user as a total combined capacity of the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to, WINDOWS MOBILE OS from Microsoft Corporation of Redmond, Wash., WINDOWS PHONE OS from Microsoft Corporation, WINDOWS from Microsoft Corporation, BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from a network 613, which can be a WWAN, a WLAN, or a WPAN. Although a single network 613 is illustrated, the network connectivity components 806 can facilitate simultaneous communication with multiple networks. For example, the network connectivity components 806 can facilitate simultaneous communications with multiple networks via one or more of a WWAN, a WLAN, or a WPAN.

The network 613 can be a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 613 can utilize various channel access methods (which might or might not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 613 can be configured to provide voice and/or data communications with any combination of the above technologies. The network 613 can be configured to or adapted to provide voice and/or data communications in accordance with future generation technologies.

In some configurations, the WWAN component 822 is configured to provide dual-multi-mode connectivity to the network 613. For example, the WWAN component 822 can be configured to provide connectivity to the network 613, wherein the network 613 provides service via GSM and UMTS technologies, or via some other combination of technologies. Alternatively, multiple WWAN components 822 can be utilized to perform such functionality, and/or provide additional functionality to support other non-compatible technologies (i.e., incapable of being supported by a single WWAN component). The WWAN component 822 can facilitate similar connectivity to multiple networks (e.g., a UMTS network and an LTE network).

The network 613 can be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 613 via the WI-FI access points. Such connections can be secured via various encryption technologies including, but not limited, WI-FI Protected Access (“WPA”), WPA2, Wired Equivalent Privacy (“WEP”), and the like.

The network 613 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing devices via the WPAN.

The sensor components 808 include a magnetometer 830, an ambient light sensor 832, a proximity sensor 834, an accelerometer 836, a gyroscope 838, and a Global Positioning System sensor (“GPS sensor”) 840. It is contemplated that other sensors, such as, but not limited to, temperature sensors or shock detection sensors, also can be incorporated in the computing device architecture 800.

The magnetometer 830 is configured to measure the strength and direction of a magnetic field. In some configurations the magnetometer 830 provides measurements to a compass application program stored within one of the memory components 804 in order to provide a user with accurate directions in a frame of reference including the cardinal directions, north, south, east, and west. Similar measurements can be provided to a navigation application program that includes a compass component. Other uses of measurements obtained by the magnetometer 830 are contemplated.

The ambient light sensor 832 is configured to measure ambient light. In some configurations, the ambient light sensor 832 provides measurements to an application program stored within one the memory components 804 in order to automatically adjust the brightness of a display (described below) to compensate for low-light and high-light environments. Other uses of measurements obtained by the ambient light sensor 832 are contemplated.

The proximity sensor 834 is configured to detect the presence of an object or thing in proximity to the computing device without direct contact. In some configurations, the proximity sensor 834 detects the presence of a user's body (e.g., the user's face) and provides this information to an application program stored within one of the memory components 804 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 834 are contemplated.

The accelerometer 836 is configured to measure proper acceleration. In some configurations, output from the accelerometer 836 is used by an application program as an input mechanism to control some functionality of the application program. For example, the application program can be a video game in which a character, a portion thereof, or an object is moved or otherwise manipulated in response to input received via the accelerometer 836. In some configurations, output from the accelerometer 836 is provided to an application program for use in switching between landscape and portrait modes, calculating coordinate acceleration, or detecting a fall. Other uses of the accelerometer 836 are contemplated.

The gyroscope 838 is configured to measure and maintain orientation. In some configurations, output from the gyroscope 838 is used by an application program as an input mechanism to control some functionality of the application program. For example, the gyroscope 838 can be used for accurate recognition of movement within a 3D environment of a video game application or some other application. In some configurations, an application program utilizes output from the gyroscope 838 and the accelerometer 836 to enhance control of some functionality of the application program. Other uses of the gyroscope 838 are contemplated.

The GPS sensor 840 is configured to receive signals from GPS satellites for use in calculating a location. The location calculated by the GPS sensor 840 can be used by any application program that requires or benefits from location information. For example, the location calculated by the GPS sensor 840 can be used with a navigation application program to provide directions from the location to a destination or directions from the destination to the location. Moreover, the GPS sensor 840 can be used to provide location information to an external location-based service, such as E911 service. The GPS sensor 840 can obtain location information generated via WI-FI, WIMAX, and/or cellular triangulation techniques utilizing one or more of the network connectivity components 806 to aid the GPS sensor 840 in obtaining a location fix. The GPS sensor 840 can also be used in Assisted GPS (“A-GPS”) systems.

The I/O components 810 include a display 842, a touchscreen 844, a data I/O interface component (“data I/O”) 846, an audio I/O interface component (“audio I/O”) 848, a video I/O interface component (“video I/O”) 850, and a camera 852. In some configurations, the display 842 and the touchscreen 844 are combined. In some configurations two or more of the data I/O component 846, the audio I/O component 848, and the video I/O component 850 are combined. The I/O components 810 can include discrete processors configured to support the various interface described below, or can include processing functionality built-in to the processor 802.

The display 842 is an output device configured to present information in a visual form. In particular, the display 842 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 842 is a liquid crystal display (“LCD”) utilizing any active or passive matrix technology and any backlighting technology (if used). In some configurations, the display 842 is an organic light emitting diode (“OLED”) display. Other display types are contemplated.

The touchscreen 844 is an input device configured to detect the presence and location of a touch. The touchscreen 844 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or might utilize any other touchscreen technology. In some configurations, the touchscreen 844 is incorporated on top of the display 842 as a transparent layer to enable a user to use one or more touches to interact with objects or other information presented on the display 842. In other configurations, the touchscreen 844 is a touch pad incorporated on a surface of the computing device that does not include the display 842. For example, the computing device can have a touchscreen incorporated on top of the display 842 and a touch pad on a surface opposite the display 842.

In some configurations, the touchscreen 844 is a single-touch touchscreen. In other configurations, the touchscreen 844 is a multi-touch touchscreen. In some configurations, the touchscreen 844 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 844. As such, a developer can create gestures that are specific to a particular application program.

In some configurations, the touchscreen 844 supports a tap gesture in which a user taps the touchscreen 844 once on an item presented on the display 842. The tap gesture can be used for various reasons including, but not limited to, opening or launching whatever the user taps. In some configurations, the touchscreen 844 supports a double tap gesture in which a user taps the touchscreen 844 twice on an item presented on the display 842. The double tap gesture can be used for various reasons including, but not limited to, zooming in or zooming out in stages. In some configurations, the touchscreen 844 supports a tap and hold gesture in which a user taps the touchscreen 844 and maintains contact for at least a pre-defined time. The tap and hold gesture can be used for various reasons including, but not limited to, opening a context-specific menu.

In some configurations, the touchscreen 844 supports a pan gesture in which a user places a finger on the touchscreen 844 and maintains contact with the touchscreen 844 while moving the finger on the touchscreen 844. The pan gesture can be used for various reasons including, but not limited to, moving through screens, images, or menus at a controlled rate and/or indicating a command to pan or move data. Multiple finger pan gestures are also contemplated. In some configurations, the touchscreen 844 supports a flick gesture in which a user swipes a finger in the direction the user wants the screen to move. The flick gesture can be used for various reasons including, but not limited to, scrolling horizontally or vertically through menus or pages. In some configurations, the touchscreen 844 supports a pinch and stretch gesture in which a user makes a pinching motion with two fingers (e.g., thumb and forefinger) on the touchscreen 844 or moves the two fingers apart. The pinch and stretch gesture can be used for various reasons including, but not limited to, zooming gradually in or out of a web service, map, or picture.

Although the above gestures have been described with reference to the use one or more fingers for performing the gestures, other appendages such as toes or objects such as styluses can be used to interact with the touchscreen 844. As such, the above gestures should be understood as being illustrative and should not be construed as being limiting in any way.

The data I/O interface component 846 is configured to facilitate input of data to the computing device and output of data from the computing device. In some configurations, the data I/O interface component 846 includes a connector configured to provide wired connectivity between the computing device and a computer system, for example, for synchronization operation purposes. The connector can be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 848 is configured to provide audio input and/or output capabilities to the computing device. In some configurations, the audio I/O interface component 848 includes a microphone configured to collect audio signals. In some configurations, the audio I/O interface component 848 includes a headphone jack configured to provide connectivity for headphones or other external speakers. In some configurations, the audio interface component 848 includes a speaker for the output of audio signals. In some configurations, the audio I/O interface component 848 includes an optical audio cable out.

The video I/O interface component 850 is configured to provide video input and/or output capabilities to the computing device. In some configurations, the video I/O interface component 850 includes a video connector configured to receive video as input from another device (e.g., a video media player such as a DVD or BLU-RAY player) or send video as output to another device (e.g., a monitor, a television, or some other external display). In some configurations, the video I/O interface component 850 includes a High-Definition Multimedia Interface (“HDMI”), mini-HDMI, micro-HDMI, DisplayPort, or proprietary connector to input/output video content. In some configurations, the video I/O interface component 850 or portions thereof is combined with the audio I/O interface component 848 or portions thereof.

The camera 852 can be configured to capture still images and/or video. The camera 852 can utilize a charge coupled device (“CCD”) or a complementary metal oxide semiconductor (“CMOS”) image sensor to capture images. In some configurations, the camera 852 includes a flash to aid in taking pictures in low-light environments. Settings for the camera 852 can be implemented as hardware or software buttons.

Although not illustrated, one or more hardware buttons can also be included in the computing device architecture 800. The hardware buttons can be used for controlling some operational aspect of the computing device. The hardware buttons can be dedicated buttons or multi-use buttons. The hardware buttons can be mechanical or sensor-based.

The illustrated power components 812 include one or more batteries 854, which can be connected to a battery gauge 856. The batteries 854 can be rechargeable or disposable. Rechargeable battery types include, but are not limited to, lithium polymer, lithium ion, nickel cadmium, and nickel metal hydride. Each of the batteries 854 can be made of one or more cells.

The battery gauge 856 can be configured to measure battery parameters such as current, voltage, and temperature. In some configurations, the battery gauge 856 is configured to measure the effect of a battery's discharge rate, temperature, age and other factors to predict remaining life within a certain percentage of error. In some configurations, the battery gauge 856 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 812 can also include a power connector, which can be combined with one or more of the aforementioned I/O components 810. The power components 812 can interface with an external power system or charging equipment via a power I/O component.

Based on the foregoing, it should be appreciated that technologies for enabling enhanced search filters for emails and email attachments in an electronic mailbox have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A computer-implemented method, the method comprising:
receiving an email comprising an email attachment;
analyzing the email attachment to determine a keyword;
modifying metadata of the email to include the keyword; and
storing the email with the modified metadata for access by a user.

2. The computer-implemented method of claim 1, wherein the email attachment comprises a picture.

3. The computer-implemented method of claim 1, wherein the email attachment comprises a video.

4. The computer-implemented method of claim 1, wherein analyzing the email attachment comprises determining the identification of at least one object in the email attachment.

5. The computer-implemented method of claim 1, wherein analyzing the email attachment comprises determining the identification of an individual in the email attachment through biometric identification.

6. The computer-implemented method of claim 1, further comprising using the keyword to generate a folder to store the email and storing the email in the folder.

7. The computer-implemented method of claim 1, further comprising:
receiving an input to search for an image from a plurality of emails;
receiving a search keyword;
searching the plurality of emails;
determining the keyword associated with the email comprising the email attachment is relevant to the search keyword; and
returning the email attachment as a search result.

8. The computer-implemented method of claim 7, wherein the search keyword is determined from a plurality of keywords generated from an analysis of the plurality of emails.

9. The computer-implemented method of claim 1, further comprising determining if the email attachment comprises a thumbnail that can provide for the generation of the keyword.

10. A computer-readable storage medium having computer-executable instructions stored thereupon that, when executed by a computer, cause the computer to:
receive an email comprising an email attachment;
analyze the email attachment to determine a keyword;
modify metadata of the email to include the keyword; and
store the email with the modified metadata for access by a user.

11. The computer-readable storage medium of claim 10, wherein the email attachment comprises a picture.

12. The computer-readable storage medium of claim 10, wherein the email attachment comprises a video.

13. The computer-readable storage medium of claim 10, wherein the computer-executable instructions to analyze the email attachment comprises computer-executable instructions to determine the identification of at least one object in the email attachment.

14. The computer-readable storage medium of claim 10, wherein the computer-executable instructions to analyze the email attachment comprises computer-executable instructions to determine the identification of an individual in the email attachment through biometric identification.

15. The computer-readable storage medium of claim 10, further comprising computer-executable instructions to use the keyword to generate a folder to store the email and store the email in the folder.

16. The computer-readable storage medium of claim 10, further comprising computer-executable instructions to:
receive an input to search for an image from a plurality of emails;
receive a search keyword;
search the plurality of emails;
determine the keyword associated with the email comprising the email attachment is relevant to the search keyword; and
return the email attachment as a search result.

17. The computer-readable storage medium of claim 16, wherein the search keyword is determined from a plurality of keywords generated from an analysis of the plurality of emails.

18. A system comprising:
a processor; and
a computer-readable storage medium in communication with the processor, the computer-readable storage medium having computer-executable instructions stored thereupon which, when executed by the processor, cause the processor to
analyze a plurality of emails to determine one or more keywords associated with a plurality of email attachments of the plurality of emails,
display the one or more keywords on a user interface,
receive input data indicating a selection of at least one keyword of the one or more keywords, and
filter the plurality of emails based on the at least one keyword to generate a set of filtered emails.

19. The system of claim 18, wherein the computer-executable instructions comprise instructions to return the plurality of email attachments associated with the set of filtered emails as a search result.

20. The system of claim 18, wherein the email attachment comprises a picture or a video.
